(19) United States
(12) Patent Application Publication
(10) Pub. No.: US 2012/0158846 A1
(43) Pub. Date: Jun. 21, 2012

(54) DIGITAL CONTENT MANAGEMENT

(76) Inventor: Jan Linder, Liebefeld (CH)

(21) Appl. No.: 13/328,103

(22) Filed: Dec. 16, 2011

(30) Foreign Application Priority Data
Dec. 17, 2010 (EP) 10195550.8

(51) Int. Cl. G06F 15/16

(52) U.S. Cl. 709/204

(57) ABSTRACT

Aspects of the present invention relate to a method of sharing content between communication devices in a communication network. The content sharing may be allowed and/or managed by a network administration module in the communication network. In this regard, the method may comprise the following steps: (1) receiving a first type of classification information related to a content emanating from a first communication device, the first type of classification information classifying the content; (2) determining where the classified content emanating from the first communication device is located; (3) determining whether the classification of the content corresponds to a second type of classification linked with a second communication device; and (4) in the case where the classification of the content corresponds to the second type of classification, then making the content available to the second communication device.

### CLAIM OF PRIORITY AND CROSS-REFERENCE TO RELATED APPLICATIONS/INCORPORATION BY REFERENCE

Pursuant to 35 U.S.C. §119, this patent application claims the filing date benefit of and right of priority to European Application No. 10195550.8, which was filed on Dec. 17, 2010.

The above stated application is hereby incorporated herein by reference in its entirety.

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

The present invention relates to content management in communication networks. More specifically, certain embodiments of the invention relate to method for sharing digital content, such as digital images among network elements in a communication network. The present invention likewise relates to corresponding communication network elements, to a communication system and to a computer program product being operable to and/or arranged to implement the method.

### BACKGROUND OF THE INVENTION

Widely available methods of content management offer a server in the internet on which this content can be stored and managed. This content can, for example, be digital images, videos or other electronic files. Many current models of photo sharing use online photo sharing websites. To share photos on these websites, the user uploads copies of their photos to the hosting server, and their friends and family can view them by downloading them to their own computer or by viewing them directly on the server.

The current models of photo sharing are undesirable for several reasons. One of the issues is related to access control. In many systems, users need to have correct access credentials, such as a user account number or name and a secret password, in order to access the content. The management of different access credentials complicates of course the use of the service. One of the drawbacks of the current solutions is how the information is spread over the different open systems interconnection (OSI) layers. This information, which can be a user profile (personal information, service registered, etc.) or a more technical parameter, such as an IP address or a serial number of the user's router, are never centralised. As a result, the user has complicated administration steps to pass to enjoy any new services.

The management of different access credentials is somewhat facilitated by a method called single sign-on that allows a user to access different types of services or web applications with the same credentials. However, the management of access credentials is not completely avoided even with the single sign-on (SSO) method. A user who wants to share his personal content like a picture album with his family does not want to manage a data bank of passwords to protect his content. Such a user is keen on having a solution without any bother.

Another issue related to photo sites that allow sharing of photos in the internet is that photos are normally thought of as being extremely personal items. People are often hesitant to load their personal pictures up to a large server database, accessible to everybody, if no access credentials are used.

Peer-to-Peer (P2P) is another solution for sharing content. The users can keep their content on their own computer, where they already are. Server storage limitations and problems related to updating multiple copies in different stores are resolved. The obvious problem with the P2P approach is that the two peers might not have their machines on at the same time.

Thus, there is a need for a solution for improving content management in communication networks

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for managing digital content in communication networks, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF THE DRAWINGS

Various features and advantages of the invention will become apparent from the following description of non-limiting exemplary embodiments, with reference to the appended drawings, in which:

FIG. 1 is a simplified network block diagram of a communication network 101 where the teachings of the present invention can be applied in accordance with the described embodiment of the present invention;

FIG. 2 illustrates how content can be shared between different devices in accordance with the described embodiment of the present invention;

FIGS. 3a and 3b illustrate a flow chart describing the content sharing method in accordance with the described embodiment of the present invention; and

FIGS. 4a and 4b illustrate a flow chart describing the content sharing method in accordance with another example of the present invention.

### DETAILED DESCRIPTION OF THE INVENTION

Certain embodiments of the present invention may be found in a method and system for digital content management, as described in the following in more detail with reference to the attached figures. The content to be shared may be, for example, digital images, but it is to be noted that the teachings of the present invention are not limited to only image sharing, but are applicable to other digital files too, such as video files. Aspects of the present invention simplify content sharing and provide a simple content sharing method for non-expert users even in situations where a single user possesses several content compatible devices. The present invention may also allow for self provisioning, by allowing linking of content to a user and to a device. In this regard, self provisioning means that a user can use a device to obtain content without setting any parameters or transfer manually the content. Rather, the provisioning mechanisms that may be implemented in accordance with various embodiments of the invention may take care of these tasks. Aspects of the present invention may also allow for self organisation of content on a communication devices. In this regard, self organisation may ensure that the right content is available to the right user(s). This may comprise use of authentication mechanisms to identify the user and to make available only the content which is tagged for this user. The present invention may also allow for self optimisation with respect to shared content. In this regard, self optimisation may comprise formatting and/or adjusting property of content based on communication device being utilized in presenting the content and/or connections being utilized in communicating the content, and doing independent of user input and/or participation—i.e. automatically. For allowing content sharing, different parameters may be collected from the end user device to ensure an outstanding content sharing experience. These parameters may be, for instance, the device user/owner or the device category. For example, the device category may comprise family device, friend device, or private device. These parameters may then be compared to the content tagging and the address book group in order to provision the device correctly as explained later in more detail. For example, a TV device tagged as family device may get access to all pictures tagged family. An address book may have a list of members or special group which defines who are the members of the family. Therefore, a member of the family who switches on his TV will be authenticated and an access will be granted to all the pictures tagged family.

Other parameters may be technical parameters, comprising, for example, information relating to supporting high definition (HD) format, WiFi capability, etc. The sharing experience may be a zero click experience when the user switches from one device to another. For example, aspects of the present invention make it possible for a user to take some pictures with his mobile phone camera and to watch them directly on his internet-connected television. This picture experience is defined by all the different actions an end user has to take in order to share his photos or to receive photos from other users. Typical user actions may comprise capturing, storing, editing and/or watching a picture.

In accordance with aspects of the present invention, the intelligence on the appropriate Open Systems Interconnection (OSI) model layers may be distributed, and a new network module may be introduced, to implement various aspect of the present invention. In the following description this network module is referred to as an administration module, and may be operable to and/or arranged to store different credentials and technical parameters used to manage the functions and tasks accomplished on the different layers defined by the OSI model. For example, the authentication for current TV service may be bound to access for quality of service and bandwidth priority and not bound to TV application. This means, for example and without limitation, that the media access control (MAC) and internet protocol (IP) addresses are associated with additional information (e.g., maximum bandwidth available, bit error rate (BER), and/or channel impulse response) about the quality of a signal transmitted from a server (IP TV signal). Furthermore, there are other credentials, such as serial number of the IP TV set top box and its related password or username and password of the user on the TV application level, for example.

Aspects of the present invention are directed to devices having internet access and which can produce, display and/or manage digital data, such as pictures including different image formats, like JPEG. The invention, however, need not be so limited. Aspects of the present invention enable the transfer of the different credentials or parameters used by different layers without asking the application layer, which interacts directly with the end user. As mentioned above the administrative module is arranged to store credentials, such as username and password of the end user, classification of the device category (family, private, friend), classification of user contacts (family, private, friend), technical parameters, e.g. BER, carrier-to-interference ratio (CIR), MAC and IP addresses.

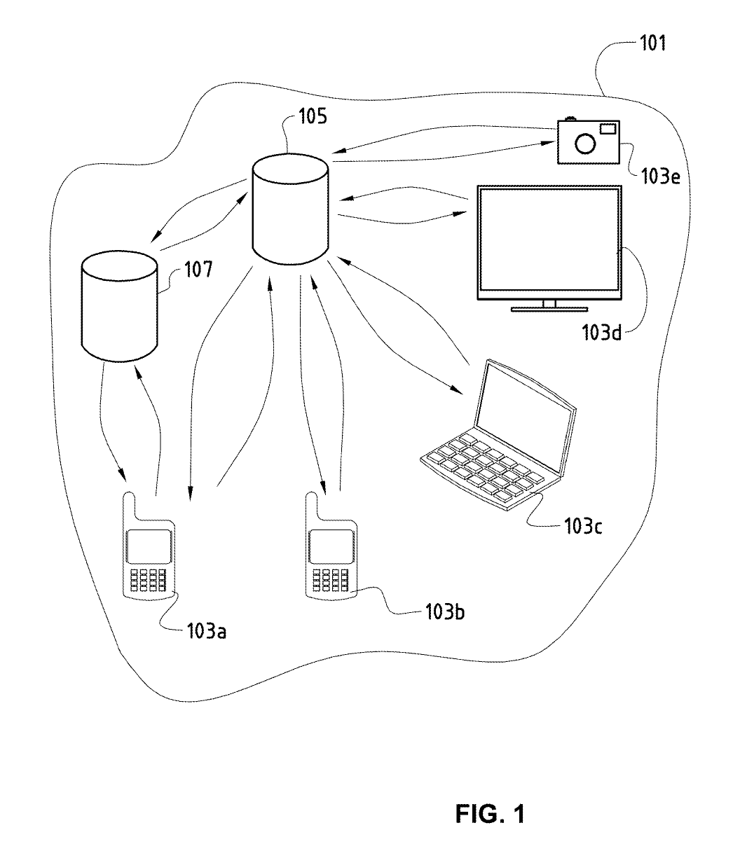

FIG. 1 illustrates a simplified block diagram of a communication network 101, in accordance with an embodiment of the present invention. In this regard, the communication network 101 may support the Internet Protocol (IP), so that communication between different network elements may be based on the IP protocol. Also illustrated in FIG. 1 are end user devices 103, an administration module 105, and a content storage server 107. Each of the end user devices 103 may comprise suitable logic, circuitry, interfaces, and/or code that may be operable to implement various aspects of the present invention. The five end user device 103 shown in FIG. 1 may comprise, for example, two mobile phones 103a and 103b, laptop computer 103c, a television 103d, and a WiFi connected digital single-lens reflex camera 103e. All of the end user devices 103 may be operable to and/or arranged to communicate with the administration module 105.

The content storage server 107 may comprise suitable logic, circuitry, interfaces, and/or code that may be operable to implement various aspects of the present invention. In this regard, the content storage server 107 may be operable to and/or arranged to store the content emanating from the communication end user devices 103. Only the end user devices 103 that want to share their content with other end user devices 103 need to be able to access this server 107. The administration module 105 may comprise suitable logic, circuitry, interfaces, and/or code that may be operable to implement various aspects of the present invention. In this regard, the administration module 105 may perform various administrative functions to support digital content management in the communication network 101, in accordance with an embodiment of the present invention. The administration module 105 may be an independent network element in the communication network 101. Alternatively, the administration module 105 may be physically integrated into another network element, as a dedicated part or component for example, or it may simply be implemented, by software for example, by another network element. The storage server 107 and the administration module 105 may be combined as a single physical unit.

In accordance with one aspect of the present invention, different end user devices 103 may be tagged or classified. Different classifications are available, such as private, friends or family. Several sub-classifications are also available, such as friends_{A}, friends_{B} and so forth. Furthermore, an end user device can belong to several classes at the same time. The device classification may be done by the user of the device 103, and it is possible to change the already given classifications.

Once the end user devices 103 are tagged, the administration module 105 can access the device classification and store this information, on the administration module 105 for example. The administration module 105 can, for example at regular intervals, interrogate the device classification from the end user devices 103. Alternatively device classification related information may be sent once from the end user devices 103 to the module 105, and end user devices 103 may send this information again to the module 105 only if the classification changes thereafter.

The content to be shared may also be tagged or classified by using the same classifications as those for the end user devices 103. The content classification may also be done by the users of the end user devices 103. In some variants, however, the content classification is done automatically without user intervention. For example, if the content to be shared is photos, the photos can be automatically tagged based on the content of the photo. This can be done based on a face recognition mechanism, where the end user device is operable to and/or arranged to implement such function. The idea can be taken further by tying this automated content tagging mechanism to the address book of the end user. For instance, a picture may be automatically tagged “family.” The administrative module 105 will check the family members within the address book of the user, and make this content automatically available for these members of this family on family tagged devices.

The content may be stored in the communication network 101 on the server 107, and the administration module 105 may be operable to and/or arranged to communicate with the server 107 to fetch the relevant content. In this regard, content classified as private is not fetched. The administration module 105 then automatically and securely distributes the fetched content to end user devices 103 that have the same classification as the content that was fetched. This content distribution may be subject to a confirmation received from these end user devices 103 indicating that they want to receive the content. The administration module 105 stores for example the following information: personal information (e.g. full name and postal address), subscribed services (e.g. email services, such as a service provider dedicated email service; TV services, such as TV services associated with particular service providers; mobile phone postpaid subscription; mobile data subscription) and device identities and/or types (e.g., mobile phone type, IP router type or voice over IP phone type) used by the customer.

The administration module 105 may be operable to and/or arranged to allow SSO functionality to simplify the use of the service for the customers. The administration module 105 may also make self provisioning possible for the end user devices 103. For instance, if the user has been registered for a long time to a photo service, e.g. a service provider dedicated Photo service, and then subscribes to the service provider dedicated TV service. The administrative module 105 may get all the necessary information to make automatically the content available on service provider dedicated TV service. This is self provisioning of service provider dedicated TV service. Moreover, different services are used through the administration module 105. The content uploading to the content storage location, i.e. to the server 107, may be based on an automatic import channel. A combination of single sign-on and intelligent network interface selector may allow uploading the content stored from an end user device 103 to the server 107 without asking the user to do any manipulation. The content is automatically transferred when the right network technology is available. Several issues can however affect the automatic upload of the content. For example, the upload may be affected by available network access technology; the source of energy of the device 103, e.g. battery or mains current; amount of energy, e.g. battery level of the device 103; amount of content, e.g. the number of pictures, queuing to be sent; and content compression method.

For example, the content may be uploaded to the server 107 only when a desired network access technology is available, and/or when the device battery level is sufficient or when the device 103 is connected to a main current. Furthermore, the upload can be initiated when certain amount of data are in the queue. Alternatively or in combination with the above aspects, the upload can also be done at regular time intervals. For example, the device 103 can at regular time intervals verify whether at least some of predefined conditions related to the above-identified issues are met, and if at least some of the conditions are met, the content can be uploaded to the server 107.

Aspects of the present invention enable, for example, a user to access his friends' shared picture albums from any screens. The administration module 105 sends an invitation to view a friend's picture album via a usual e-mail for example. This may be done via the address book of the user which contains all the information about private contacts, family and friends groups. Aspects of the present invention enable access to the shared content album not only from a PC web browser, but also from any other screens. A guest may receive a notification on his mobile phone, IP TV and PC web browser or any additional connected screens like a digital picture frame device. The invitation information may be broadcast in the IP network connecting the different end user devices 103. This approach allows a full integrated and seamless experience for the guest, and tends towards a zero click experience.

In accordance with an embodiment of the present invention, network parameters may be used on the seven different OSI based layers, described in Table 1 (below). The administration module 105 knows which layer needs which parameters to actively provide this information, without asking the upper layer and ending up with a complicated user interaction. One or more embodiments of the present invention may use the standard OSI model and standard protocols like IPv4 or hypertext transfer protocol secure (HTTPS). Some examples about the parameters and information, which are used on the different layers to handle the content experience in a multi-screen environment, are illustrated below.

TABLE 1
Overview of the OSI model
OSI model
Host Layers

| Data unit | Layer | Function |
|---|---|---|
| Data | 7. Application | Network process to application |
| | 6. Presentation | Data representation, encryption & |
| | | decryption |
| | 5. Session | Interhost communication |
| Segments | 4. Transport | End-to-end connection and reliability |

Media Layers

| | | |
|---|---|---|
| Packet | 3. Network | Path determination and IP |
| Frame | 2. Data link | Physical addressing |
| Bit | 1. Physical | Media, signal and transmission |

In accordance with one or more embodiments of the present invention, the following features characterise the different OSI layers.

Physical layer: Fiber network brings about a real change in terms of user experience. For instance, fast upload during the day is enabled. Software as a service makes, for example, the picture editing function possible.

Data link layer: Seamless transfer from one device to another is enabled. A virtual interface allows transferring a picture stream session from one device to another without interruption.

Network layer: People and device profiles are bound to access profiles. A network operator is used to manage the service. For example, the authentication for the current TV service is bound to the access for quality of service and bandwidth priority and not bound to a TV application. TV applications typically use a username and password, but in a proposed alternative, the authentication request uses more information, e.g. what type of access the user has (integrated services digital network (ISDN), digital subscriber line (DLS), very high speed DLS (VDSL)) and the quality of the signal. If the quality of the signal is not good enough, no access to a TV application is provided. Or if the customer wants to have more bandwidth, a bandwidth priority mechanism checks the different criteria (describing the quality of the signal) to allow the user to get the requested bandwidth.

Transport layer: End-to-end connection function, such as re-send pictures or incremental picture uploads, ensures the reliability of the service and performance without annoying the user by asking to re-send pictures.

Session layer: Automatic sessions are managed to ensure a convenient data transfer across the distributed platform. Examples are automatic picture upload from a mobile phone to the internet or automatic web picture album creation for a TV.

Presentation layer: Icons, menu item lists, folder structures, pagination and views have the same design, and are consistent across the different platforms. Pictures are resized and optimised for different presentations such as TV and mobile phones.

Application layer: Different modes, like edit (picture, e-mail) or compose (e-mail, short messages) or view and preview guide the user and bring an intuitive cross-platform user experience.

Besides the functions which are designed on the seven OSI layers, the administration module 105 is defined on the application layer. The administration module 105 may collect the different information to reduce the user interaction and thus to move towards a zero click experience. In this regard, a particular function of the administration module 105 may be to store personal information to ease the subscription to a new service. This may comprise service providers' dedicated and/or unique services. For example, a service provider's Photo service may comprise a service which may allow the user to store all his pictures from a mobile phone or DSLR camera in a centralised storage, and then accessing them from any web browser or via TV, using the service provider dedicate TV service for example.

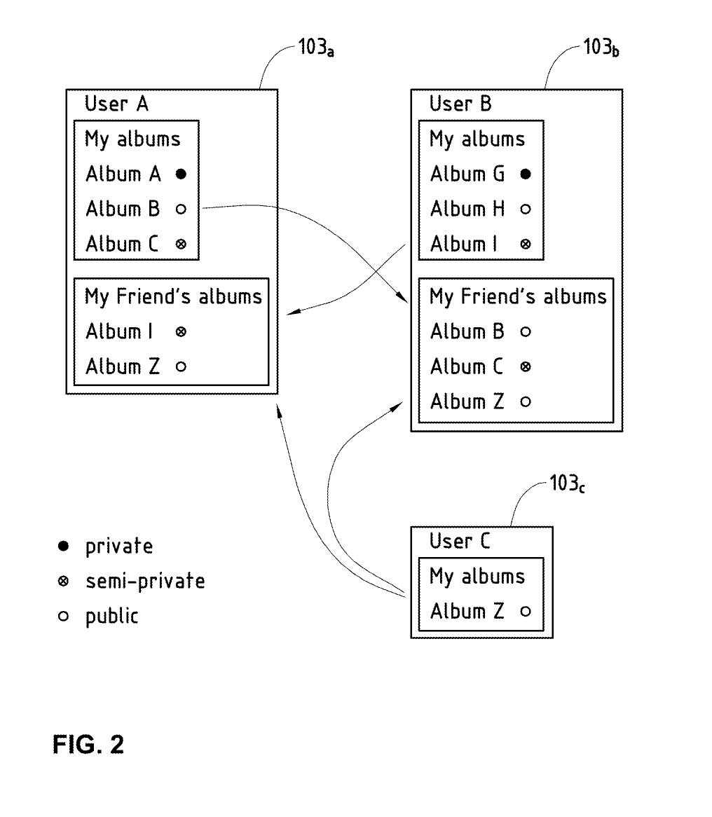

The “trusted friends” concept provided by aspects of the present invention uses the administration module 105 to store credentials of the users and enable the interconnection between the members of the content sharing service. In this regard, FIG. 2 shows a typical example of image sharing between different user end user devices 103a, 103b and 103c.

The administration module 105 may be operable to and/or arranged to manage and store different services and related parameters, such as mobile phone number, e-mail address, internet access type (dial-up, digital subscriber line, etc.) or IP TV service. The administration module 105 stores not only service information, but also device information.

A device 103 connected to a wireless or wired network of an internet service provider (ISP) may be automatically identified by the administration module 105 and tied to a specific service. For instance, a mobile phone needs a subscriber identity module (SIM) card to authenticate the user and thus to offer a voice service. The authentication mechanism may use a so-called mobile subscriber integrated services digital network number (MSISDN) to check the identity of the user and grant access to the network. The MSISDN may be stored in the administration module 105, and can be managed by the user or a customer centre. Aspects of the present invention allow the administration module 105 not only to manage the registered services and the end user devices 103 related to them, but also to manage the content handled by these end user devices 103.

Next, an example is described in more detail with respect to FIG. 2. In this example, the end user devices 103 are tagged with three different tag types: private, family and friends. Once the service is activated and registered in the administration module 105, the administration module 105, or any other suitable network element within the ISP infrastructure, may be able to find out the device classification for the device that is used to access the subscribed service. A separate process may then ask the user if the device is “private”, “family” or “friend”. This may be done by the administration module 105. In this regard, the administration module 105 knows which content can be fetched by a specific device 103. For example, in the case of service provider TV services, a family member who switches on the TV device associated with the service provider TV service, tagged or classified as a family device, has access only to the family content. The administration module 105 grants access to the correct content. In a further extension of this embodiment, the TV device may have a face recognition mechanism to authenticate the user switching on the TV and only the user specific content is made available, in this case the family content and the friends' content. Friends' content can be managed in the address book which contains the information not only to share automatically the content to the listed friends, but also access the friends' content.

Each user can store personal content using the proposed service, for example store personal data, in the network. This content is also tagged with exactly the same tag types: private, family and friends. The content is tagged by the users of the end user devices 103. This information is transmitted to the administration module 105, and thus this module is informed about the status of the personal content available on the connected end user devices 103.

The administration module 105 may then broadcast the personal content to the different personal services (devices) according to the defined tags. For example, content from one device 103 tagged with family may be transmitted to other devices with the very same family tag. Taking the example of FIG. 2, the album C from device 103a is transmitted by the administration module 105 to the device 103b, which has the same tag as the album C. The main advantage is the availability of the personal content to the different end user devices 103 without any complicated user interaction.

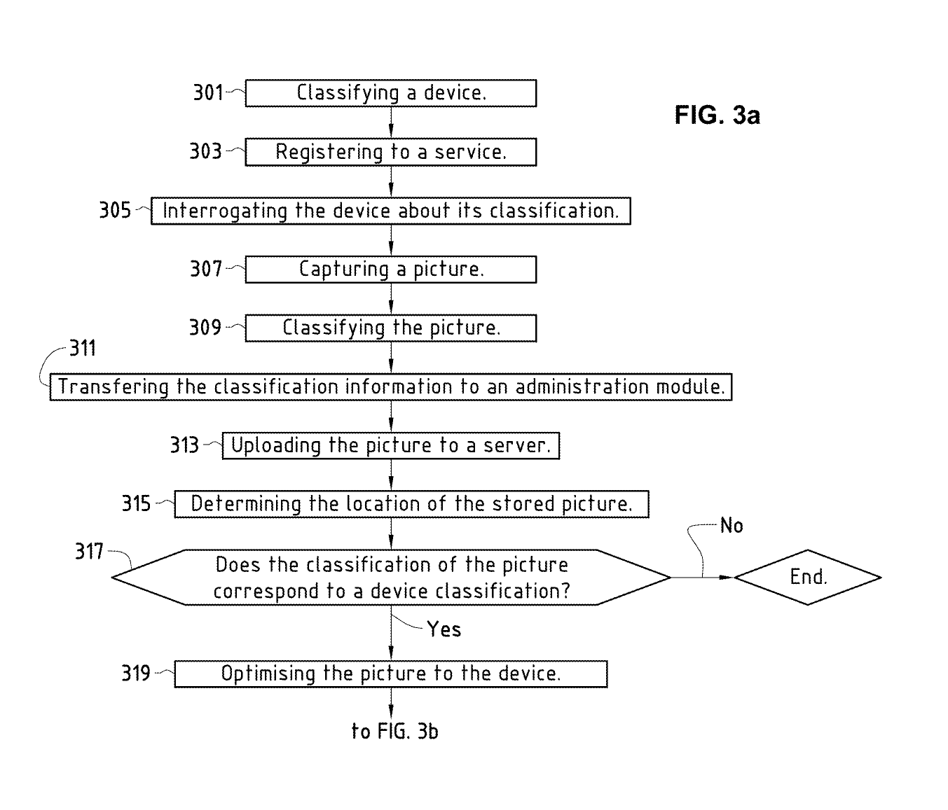

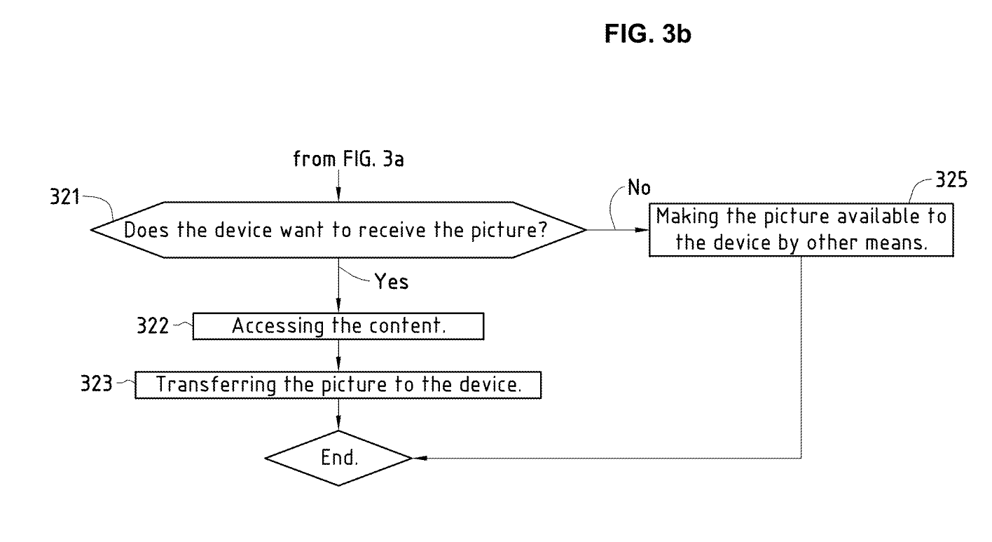

The above example is illustrated by the flow chart of FIGS. 3a and 3b, with reference to FIG. 1. In step 301 different end user devices 103 are classified. Then in step 303, all of the end user devices 103 register with the administration module 105. In this step the end user devices 103 can also be authenticated by the administration module 105 and/or the administration module 105 is informed about the device types of the end user devices 103. In step 305 the administration module 105 interrogates the end user devices 103 about their classifications.

In step 307, an end user device 103 may generate content. For example, the device 103a may capture a picture, by using its integrated camera for example. Next in step 309 the user of the device 103a classifies the picture. Once this is done, in step 311 this classification information can be transferred to the administration module 105. In step 313 the device 103a uploads the captured picture to the server 107 for storage. The administration module 105 is informed in step 315 about the location of the stored picture.

In step 317, it is determined whether the classification of the picture corresponds to the classification of the other registered end user devices 103b, 103c or 103d. If none of the device classifications matches the picture classification, then the process can be terminated. If, on the other hand, at least one of the other device classifications matches the content classification, then in step 319 the picture can be optimised, for instance resized, to the devices with the same classification as the content.

In step 321, it is determined whether the devices actually want to receive the photos. If the response is in the affirmative, then in step 322 the administration module accesses the picture, and in step 323 the picture can be transferred to the devices that have the same classification as the content. If, on the other hand, in step 321 it was determined that the devices do not want to receive the picture, it can be made available to these devices by some other means, for example by storing it on another server and giving access rights to these devices, so that these devices can access the picture at a later moment in time. After steps 323 and 325, the process comes to an end.

In another embodiment of the invention, instead of or in addition to taking advantage of the device classification, another component can come into play, namely an address book. In accordance with this embodiment of the present invention, the address book can be connected to personal content. In this regard, a user's address book may have a group definition which manages the access to personal content. For example, a family group policy permits a family member who belongs to this group to access automatically the personal content tagged as family from any of his family devices. The address book application may be bound to the administration module 105 which grants access to the different screens or devices. It may use a sharing mechanism each time the user is interested in distributing or viewing family or friends' content on the user's own devices.

For example, as in the embodiment illustrated above, the address book may also contain the same three tag types in contact details as device and content: private, family and friends. The personal address book may be a registered service on the administration module 105. In this simplified example, a member of the family, for instance the father, has three contacts tagged family in his personal address book, James, Dhiren and Gavin. James wants to share his personal content with his family. Therefore, he tags his personal content with “family”. The administration module 105 gets the information that James has “family” content and looks up who are the family members of James. This can be done either by looking at the address book of James or looking at the address books of other users. James is also registered for online photo service, and he is known by the administration module 105.

The search result is James's father because father's address book contains James, Dhiren and Gavin with the family tag, or alternatively James's address book shows that his father is tagged with family. In a further extension of this example, this look up mechanism also finds out that the father has two devices which are “family” tagged. Thus, the administration module 105 broadcasts James's personal content directly to the father's personal end user devices 103. Consequently the father received directly new content from his child James without any interaction thanks to the information and different look up and broadcast mechanisms contained in the administration module 105.

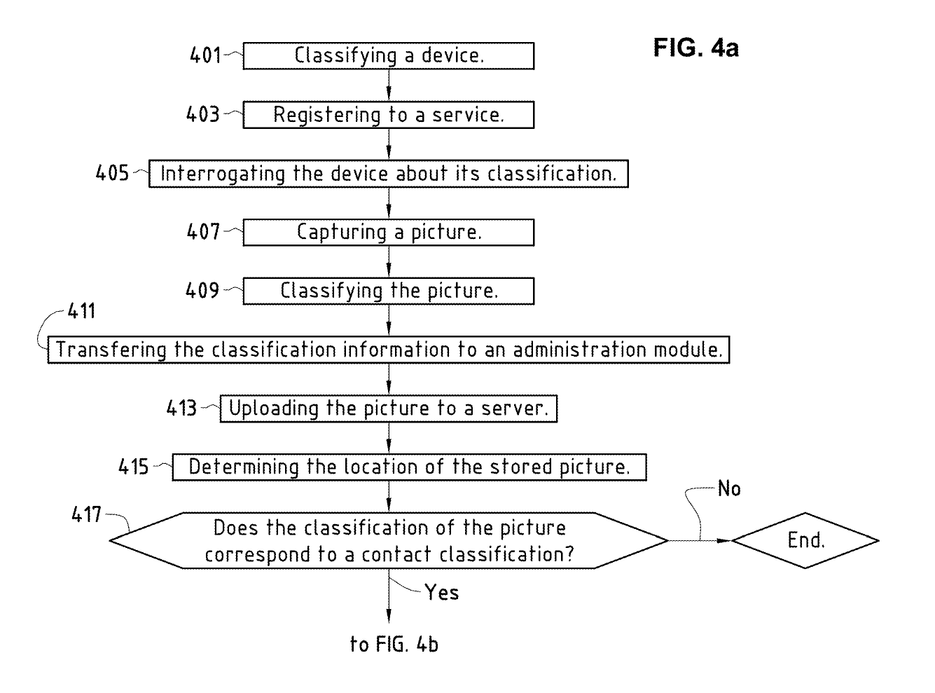

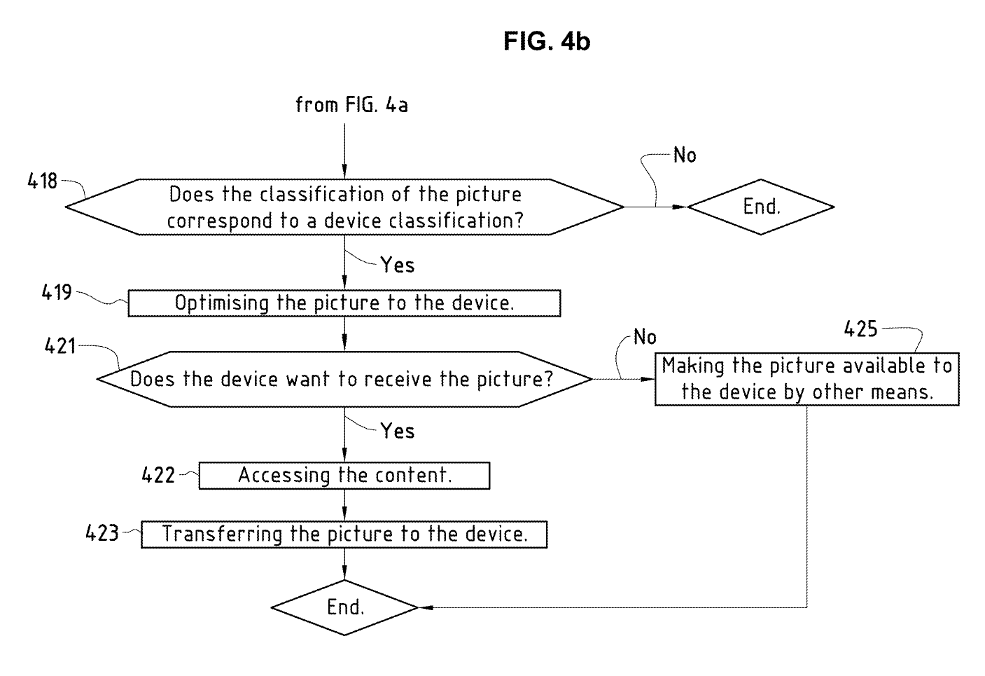

This example is illustrated by the flow chart of FIGS. 4a and 4b. It is almost identical to the flow chart of FIGS. 3a and 3b. Only the step 317 is replaced with steps 417 and 418. In other words, in accordance with the flow chart of FIG. 4, a two-step classification step is done. First the content classification is compared with a contact classification of an address book and then the content classification is compared with a device classification. It is also possible to perform the step 418 first and then the step 417. Also, in these two flow charts, the order of some other steps could be changed.

According to a first aspect of the invention, a method is provided for a first communication device (e.g. 103a) to share content with at least a second communication device (e.g. 103b) in a communication network (e.g. 101). Thus, aspects of the present invention propose a new method to grant access to a shared content in a secure way and with minimal effort from the user. In a complex environment, tools are provided which help the end user to handle easily the user's content, which may comprise pictures for example. The method is not device dependent, i.e. the content can be made available to any type of device. The content can be for example digital pictures, in which case the first device may pull the content from a picture application. In accordance with an embodiment of the invention, no intelligent mechanism is required the picture application itself in the devices. Rather, the picture application needs only to support content classification. The picture application classifies the picture with the right status, for example family or friends.

Furthermore, the proposed method brings automatically a centralised content management, such as using the administration module 105 for example. It makes it possible to a share user's personal content in a private environment without additional credentials. Content proprieties, such as the metadata of a picture, may contain the classification information. The method may be run in real-time or very close to real-time, in which case communication devices may be informed in real time about a new digital content. The content can be stored on a server in the network, such as the content storage server 107, and the content, once it becomes available on the first communication device, may be automatically uploaded to this server.

The proposed method can also be used for self organisation of content (e.g. pictures) on a communication device (e.g., a computer or a television). In this regard, self organisation may ensure that the right content is available to the right user(s). The basic idea here is to use an authentication mechanism to identify the user and to make available only the content which is tagged for this user. For instance, in Internet Protocol TV (IPTV) based implementation, the access is granted if a person is a member of a family X and the TV is tagged family X. The IPTV is connected to the content of family X. There can be a camera on the IPTV to authenticate the mother X of the family X and only the family content is displayed, not other private content.

The proposed method also allows self optimisation with respect to shared content, such as for a picture slideshow on a computer or television in IPTV based implementation for example. For example, a picture shot with a high definition device will be displayed in high definition if the TV is of high definition. Otherwise the picture will be resized to a normal format. In the same way we can optimise a slideshow on a digital picture frame.

The user of the first communication device and/or the second communication device may also be authenticated. This improves the picture experience for the end user. For example, the IPTV can have a mechanism to authenticate the user automatically. No user interaction is needed. A zero click experience is offered.

Self provisioning is another one of the main advantages offered by the present invention. In this regard, aspects of the invention allow linking of content to a person and to a device. Here, the self provisioning means that a person can use a device to obtain his picture without setting any parameters or transfer manually his picture. The provisioning mechanism takes care of this task.

According to a second aspect of the invention, a computer program product is provided for implementing the steps of the method according to the first aspect of the present invention when loaded and run on computer means of network elements.

According to a third aspect of the invention, various network elements may be operable to and/or arranged to support the present invention, and/or to implement various functions related thereto. These network elements may comprise servers for providing storage and/or centralized administration roles, and communication devices for uploading and/or handling content that is shared

It is to be noted that the teachings of the invention are not limited to any specific network access technology. Also the teachings of the invention are applicable both in wireless (e.g. any generation cellular networks or wireless local area networks) and wired networks (e.g. universal serial bus (USB) or wired local networks).

The invention likewise relates to a computer program product comprising instructions for implementing the steps of the method described above, when loaded and run on computer means of the administration module 105 capable of implementing the method.

While the invention has been illustrated and described in detail in the drawings and foregoing description, such illustration and description are to be considered illustrative or exemplary and not restrictive, the invention being not limited to the disclosed embodiment. Other embodiments and variants are understood, and can be achieved by those skilled in the art when carrying out the claimed invention, based on a study of the drawings, the disclosure and the appended claims. In particular, the content emanating from the end user devices 103 can be stored on these very same end user devices 103, i.e. in that case there would be no need for the specific storage server 107.

In the claims, the word “comprising” does not exclude other elements or steps, and the indefinite article “a” or “an” does not exclude a plurality. A single processor or other unit may fulfil the functions of several items recited in the claims. The mere fact that different features are recited in mutually different dependent claims does not indicate that a combination of these features cannot be advantageously used. Any reference signs in the claims should not be construed as limiting the scope of the invention.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method, comprising:
handling by a network administration module, content sharing between a first communication device and a second communication device in a communication network, the handling comprising:
receiving, by the network administration module, a first type of classification information related to a content emanating from the first communication device, the first type of classification information classifying the content;
determining where the classified content emanating from the first communication device is located;
determining whether the classification of the content corresponds to a second type of classification linked with the second communication device; and
when the classification of the content corresponds to the second type of classification, making, by the network administration module, the content available to the second communication device.

2. The method according to claim 1, comprising receiving by the network administration module, before making the content available, an indication from the first communication device that the content is available, and, in response to a confirmation from the second communication device, accessing the content and transmitting the content to the second communication device.

3. The method according to claim 1, wherein the second type of classification is at least one of the following: a device classification, a contact classification of an address book and a user classification of the second communication device.

4. The method according to claim 1, wherein the classified content is made available to the second communication device only if the classification of the content also corresponds to a third type of classification related to the second communication device or to user of the second communication device.

5. The method according to claim 4, wherein the second type of classification is an address book classification or a user classification of the second communication device, and the third type of classification is device classification.

6. The method according to claim 5, comprising determining by the network administration module, at least one contact classification in the address book of the first communication device or at least one contact classification in the address book of the second communication device, and comparing this contact classification to the content classification.

7. The method according to claim 1, comprising receiving by the network administration module, service registration information from the first communication device and/or from the second communication device.

8. The method according to claim 7, wherein the service registration information indicates to the network administration module where the content of the first communication device is stored and/or device type of communication device transmitting the registration information.

9. The method according to claim 8, comprising resizing and/or optimising by the network administration module, the content to the second communication device based on the device type of the second communication device.

10. The method according to claim 1, wherein the classified content is stored on at least one of the following network elements: the network administration module, a network storage server and/or the first communication device, the network elements being physically different elements.

11. The method according to claim 1, comprising authenticating by the network administration module, user of the first communication device and/or user of the second communication device.

12. The method according to claim 1, wherein the first communication device uploads the content to its storage location, the uploading being affected by at least one of the following: available network access technology, battery level of the first communication device, the source of energy of the first communication device, the amount of content to be uploaded and content compression method.

13. A system, comprising:
a network element that is utilized in a communication network to administer sharing of content between a first communication device and a second communication device, the network element being operable to:
receive a first type of classification information related to a content emanating from the first communication device, the first type of classification information classifying the content;
determine where the classified content emanating from the first communication device is located;
determine whether the classification of the content corresponds to a second type of classification linked with the second communication device; and
make the content available to the second communication device if the classification of the content corresponds to the second type of classification.

14. The system according to claim 13, wherein the network element is operable to receive, before making the content available, an indication from the first communication device that the content is available, and, in response to a confirmation from the second communication device, to assess the content and transmit the content to the second communication device.

15. The system according to claim 13, wherein the network element is operable to determine at least one contact classification in the address book of the first communication device or at least one contact classification in the address book of the second communication device, and comparing this contact classification to the content classification.

16. The system according to claim 13, wherein the network element is operable to receive service registration information from the first communication device and/or from the second communication device.

17. The system according to claim 13, wherein the network element is operable to resize and/or optimise the content to the second communication device based on the device type of the second communication device.

18. The system according to claim 13, wherein the network element is operable to authenticate user of the first communication device and/or user of the second communication device.

19. A system, comprising:
a communication device that is utilized in sharing content with at least one other communication device in a communication network, the communication device being operable to:
obtain content to be shared;
classify the content;
classify the communication device or at least one contact in its address book;
send information about the content classification to a network element in the communication network, the network element comprising a network administration module; and
transfer the content within the communication network.

20. The system according to claim 19, wherein the communication device is operable to upload the content to a storage location of the communication device, the uploading being affected by at least one of the following: available network access technology, battery level of the communication device, the source of energy of the communication device, the amount of content to be uploaded and content compression method.
